(19) United States
(12) Patent Application Publication
(10) Pub. No.: US 2014/0052378 A1
(43) Pub. Date: Feb. 20, 2014

(54) METHODS AND CORRESPONDING SOFTWARE MODULE FOR QUANTIFYING RISKS OR LIKELIHOODS OF HYDROCARBONS BEING PRESENT IN A GEOLOGICAL BASIN OR REGION

(71) Applicants: Gary Patrick Albert Muscio, Houston, TX (US); Jonathan David Finstuen, Houston, TX (US)

(72) Inventors: Gary Patrick Albert Muscio, Houston, TX (US); Jonathan David Finstuen, Houston, TX (US)

(73) Assignee: Chevron U.S.A. Inc., San Ramon, CA (US)

(21) Appl. No.: 13/585,508

(22) Filed: Aug. 14, 2012

(51) Int. Cl. G01V 1/30; G01V 9/00; G01V 1/34; G06F 19/00

(52) U.S. Cl. 702/13

(57) ABSTRACT

Described herein are various embodiments of methods and corresponding hardware and software configured to quantify the risk or likelihood of hydrocarbons being present in a geological region. In such methods, first and second sets of regional or basin data corresponding to spatial and temporal variations in respective first and second petrophysical properties over at least portions of the region are generated, followed by generating a third set of regional data on the basis combining at least portions of the first and second sets of data. A visual display of the third set of data provides quantitative visual indications of degrees of risk or likelihood that hydrocarbons are present in the region at specified locations thereof.

### FIELD

Various embodiments described herein relate to the field of methods and software for determining the risk or likelihood of hydrocarbons being present in a geological region.

### BACKGROUND

Two common tasks in a geological basin analysis project are: (1) analyzing the history of how physical properties in a given petroliferous basin change as a function of geologic age (“timing”), and (2) analyzing the timing of one or more specific physical properties in the basin with respect to the timing of other relevant petroleum system parameters such as trap formation, reservoir deposition, and seal formation. Both steps are important when evaluating the economic risks associated with a given petroleum exploration opportunity. Typically, various types of maps or graphs are generated that represent the first and second steps. Rendering the information provided by such steps into a coherent visual or other format that is amendable to quick and reliable interpretation by an analyst or scientist has proven difficult, however, more about which we now say.

FIG. 1(a) illustrates one prior art method 100 of generating a series of physical property maps at different geologic ages that are relevant to the history of a basin. In method 100, images or maps depicting the changes of respective first and second petrophysical properties over a geological basin or region are developed at steps 102 and 104. These two maps or images are then combined at step 106 to provide a visual comparison between the two different petrophysical properties, which in turn generates a resulting indication of qualitative risk at step 108.

Maps illustrative of the type generated by method 100 of FIG. 1(a) are shown in FIG. 1(b). FIG. 1(b) shows a series of maps or images indicative of transformation ratio at different geologic ages in a given geological basin. Transformation ratio, expressed in percent transformed, is the ratio of petroleum (i.e., oil plus gas) that is actually formed by kerogen to its genetic potential (or the total amount of petroleum that the kerogen is capable of generating). A separate display can be used to create an image that shows how the physical property of a related petroleum system element (such as time of top seal formation, time of trap formation, or time of reservoir deposition) changes with time. FIG. 1(b) shows how transformation ratios change through time (as represented by maps from ages 21.8 ma, 17.7 ma, 13 ma, 10.2 ma, 3.8 ma and 0 ma), from low values (red/green) at early ages to higher values (yellow/red) at more recent ages. The method of FIG. 1(a) will now be seen to be limited to providing a qualitative visual comparison only of how a given physical property changes as a function of geologic age.

FIG. 2(a) illustrates another prior art method 200 of generating a geologic age chart that shows first and second petrophysical properties A and B as a function of geologic time. In method 200, a geologic age chart is generated at step 202 that depicting the changes of the first and second petrophysical properties as a function of geologic time. At step 204, the resulting chart provides a visual comparison between the two different petrophysical properties at a single X-Y location, which in turn generates a resulting indication of qualitative risk at step 206.

Charts illustrative of the type generated by method 200 of FIG. 2(a) are shown in FIG. 2(b). FIG. 2b shows a maturity (expressed in % vitrinite-Ro, 240) map (230) for a source rock in a petroliferous basin. The two bottom charts (215 and 225) indicate the transformation ratio (or “generation”) curve of the source rock for two different locations in the basin, with the depositional ages of three target reservoirs (deep, middle, shallow) superimposed upon one another. The various charts of FIG. 2(b) plot physical properties versus geologic age at a single X-Y location in a basin (as opposed to on a map), and provide an indication of the timing relationships of selected physical properties with respect to the timing of a related petroleum system element (e.g., the age at which reservoir deposition occurred).

The method of FIG. 2(a) will now be seen to be limited to providing a qualitative visual comparison only of how a given physical property changes as a function of geologic age at a single X-Y location (and not over an entire area of interest). It will now also be understood that methods 100 and 200 of FIGS. 1(a) and 2(a) only allow visual comparisons and qualitative assessments of timing relationships that impact geological risk.

What is needed are improved means and methods for quantifying the risks or likelihoods of hydrocarbons being present in a geological region that are not limited to a single petrophysical property or a single X-Y location in a basin or region of interest.

### SUMMARY

According to one embodiment, there is provided a computer-implemented method of quantifying a risk or likelihood of hydrocarbons being present in a geological region comprising generating a first set of regional data corresponding to spatial and temporal variations in a first petrophysical property over at least portions of the region, generating a second set of regional data corresponding to spatial and temporal variations in a second petrophysical property over at least portions of the region, generating a third set of regional data on the basis of at least portions of the first and second sets of data, the third set of data corresponding to combined spatial and temporal variations in the first and second petrophysical properties over the at least portions of the region, and generating a visual display of the third set of data configured to provide quantitative visual indications of degrees of risk or likelihood that hydrocarbons are present in the region at specified locations thereof, wherein each of the foregoing steps is performed by a processor operating in conjunction with a data storage device or memory, the processor being configured to execute instructions to perform each of the foregoing steps.

According to another embodiment, there is provided a software module comprising first computer readable means stored in the computer readable medium and configured to generate a first set of regional data corresponding to spatial and temporal variations in a first petrophysical property over at least portions of a geologic region, second computer readable means stored in the computer readable medium and configured to generate a second set of regional data corresponding to spatial and temporal variations in a second petrophysical property over at least portions of the region, third computer readable means stored in the computer readable medium and configured to generate a third set of regional data on the basis of at least portions of the first and second sets of data, the third set of data corresponding to combined spatial and temporal variations in the first and second petrophysical properties over the at least portions of the region, and fourth computer readable means stored in the computer readable medium and configured to generate a visual display of the third set of data configured to provide quantitative visual indications of degrees of risk or likelihood that hydrocarbons are present in the region at one or more specified locations thereof, wherein the software module is stored in at least one computer readable medium and is configured for execution by a computer or processor, each of the foregoing steps is performed by the processor operating in conjunction with a data storage device or memory, the processor being configured to execute instructions to perform each of the foregoing steps.

In yet another embodiment, there is provided a computer system configured to provide quantitative visual indications of degrees of risk or likelihood that hydrocarbons are present in the region at one or more specified locations thereof comprising a data source containing a first set of regional data corresponding to spatial and temporal variations in a first petrophysical property over at least portions of a geologic region, and a second set of regional data corresponding to spatial and temporal variations in a second petrophysical property over at least portions of the region, a computer processor configured to execute at least one computer module configured to generate a third set of regional data on the basis of at least portions of the first and second sets of data, the third data set corresponding to combined spatial and temporal variations in the first and second petrophysical properties over the at least portions of the region, and a display configured to visually show the third set of data to a user, the third set of data providing a quantitative visual indication of degrees of risk or likelihood that hydrocarbons are present in the region at one or more specified locations thereof.

Further embodiments are disclosed herein or will become apparent to those skilled in the art after having read and understood the specification and drawings hereof.

### BRIEF DESCRIPTION OF THE DRAWINGS

This patent or application file contains at least one drawing executed in color. Copies of this patent or patent application publication with color drawing(s) will be provided by the Office upon request and payment of the necessary fee. Different aspects of the various embodiments of the invention will become apparent from the following specification, drawings and claims in which:

FIG. 1(a) illustrates one prior art method 100 of generating a series of physical property maps at different geologic ages;

Maps illustrative of the types generated by method 100 of FIG. 1(a) are shown in FIG. 1(b);

FIG. 2(a) illustrates another prior art method 200 of generating a geologic age chart;

FIG. 2(b) shows charts illustrative of the type generated by method 200 of FIG. 2(a);

FIG. 3(a) shows one embodiment of a method 300 for quantifying risks or likelihoods of hydrocarbons being present in a geological region or basin.

FIGS. 3(b) and 3(c) show examples of first and second basin maps generated in accordance with one embodiment of methods associated with FIG. 3(a);

FIG. 3(e) shows one embodiment of a visual risk map generated on the basis of the first and second basin maps of FIGS. 3(b) and 3(c);

FIG. 3(d) shows further details associated with the generation and interpretation of FIGS. 3(b) and 3(c), and the generation of the risk map shown in FIG. 3(e), and

FIG. 4 shows a system configured to implement various embodiments of the methods disclosed herein.

The drawings are not necessarily to scale. Like numbers refer to like parts or steps throughout the drawings, unless otherwise noted.

### DETAILED DESCRIPTIONS OF SOME EMBODIMENTS

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple computer processors, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

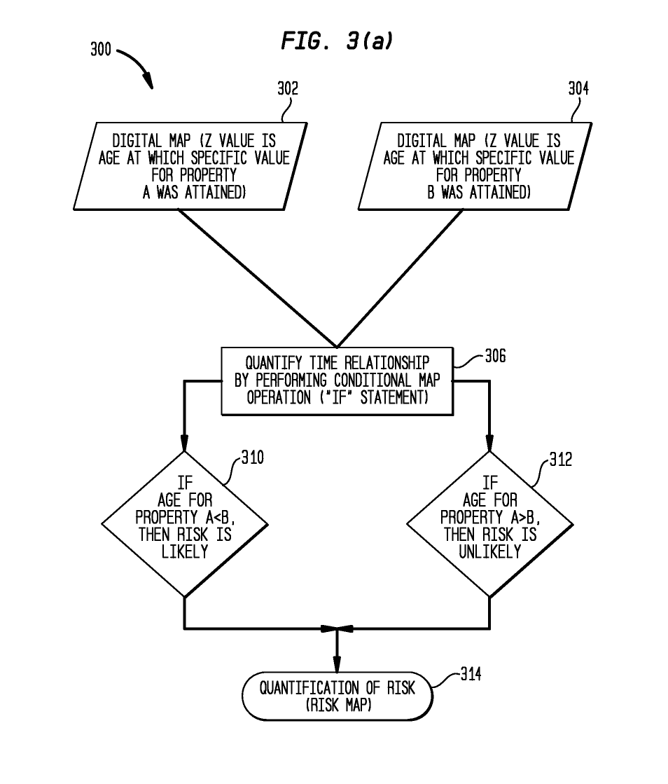

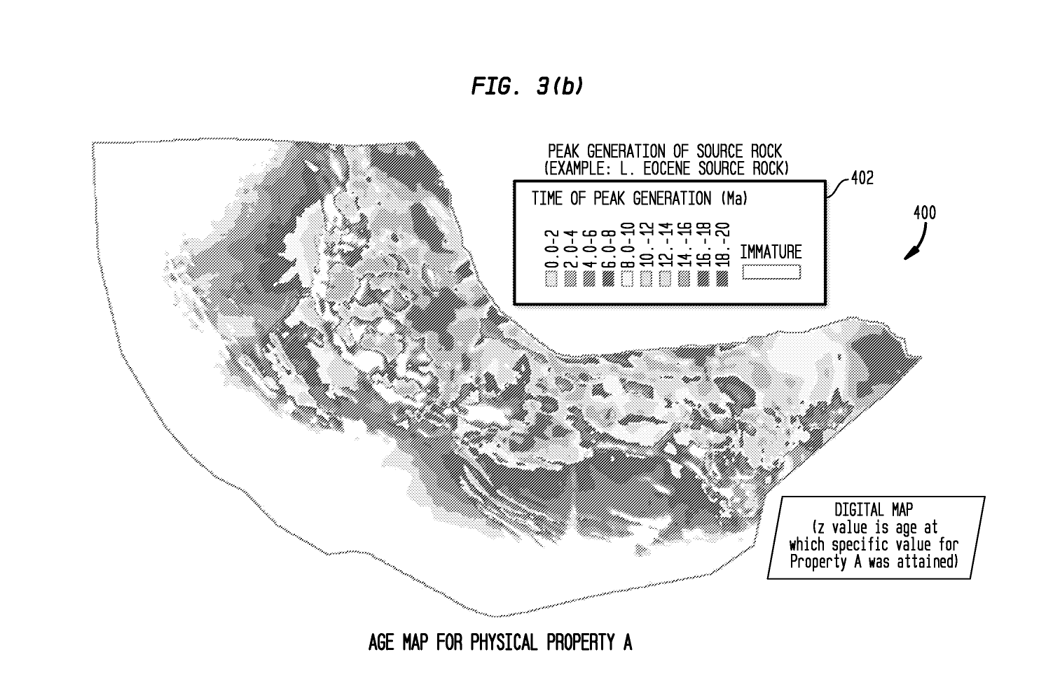

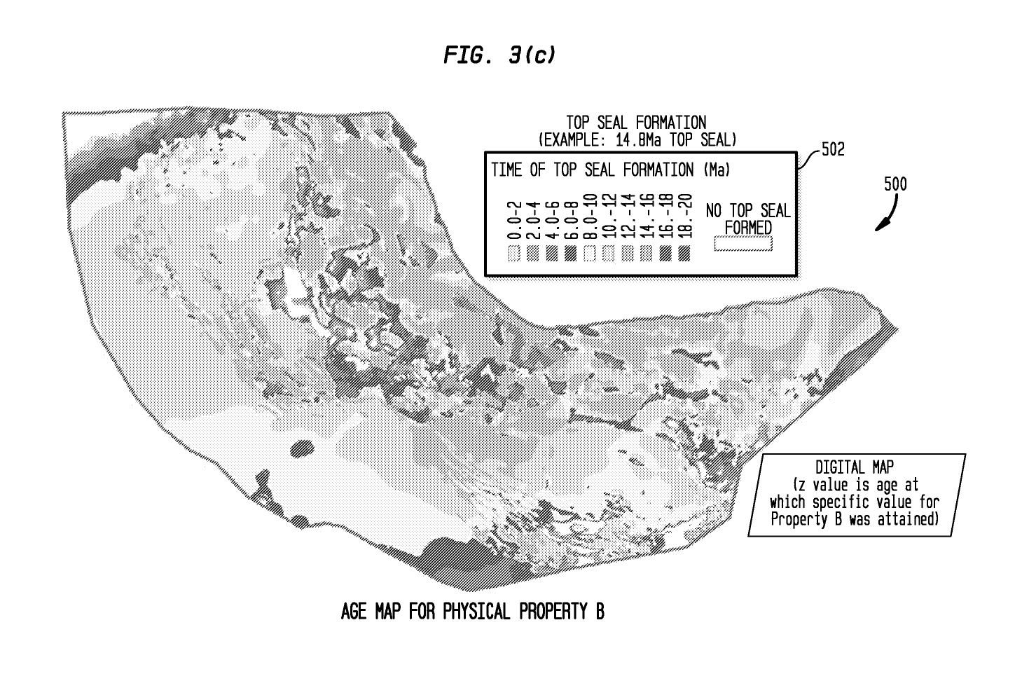

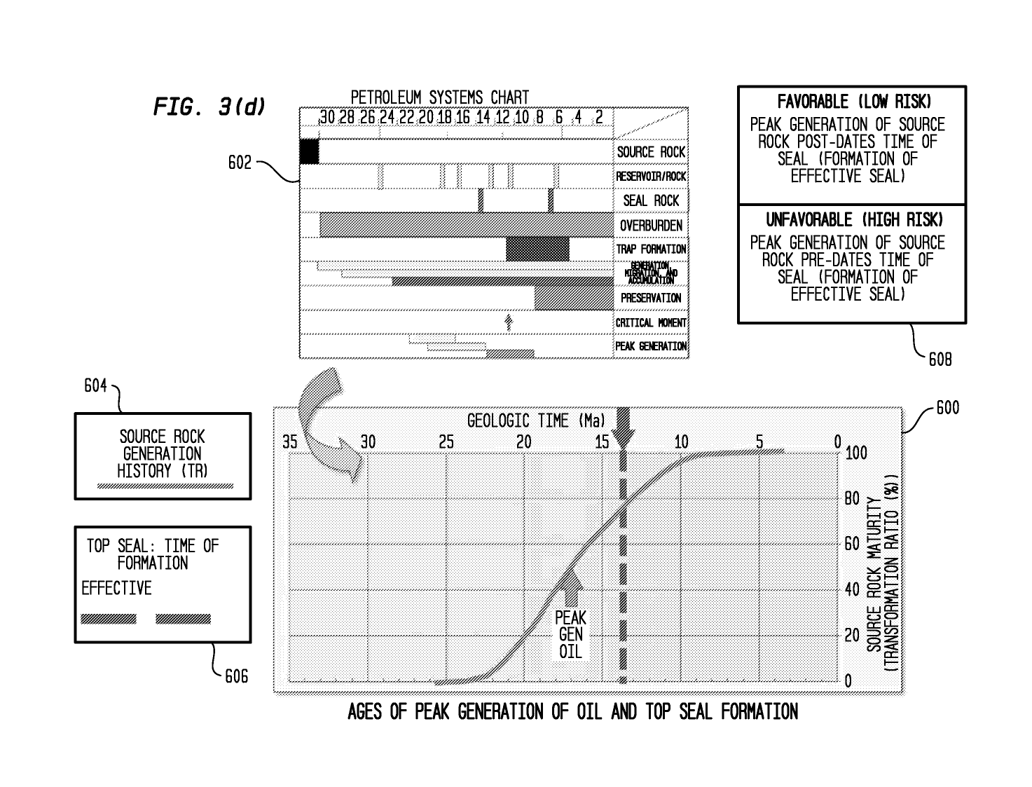

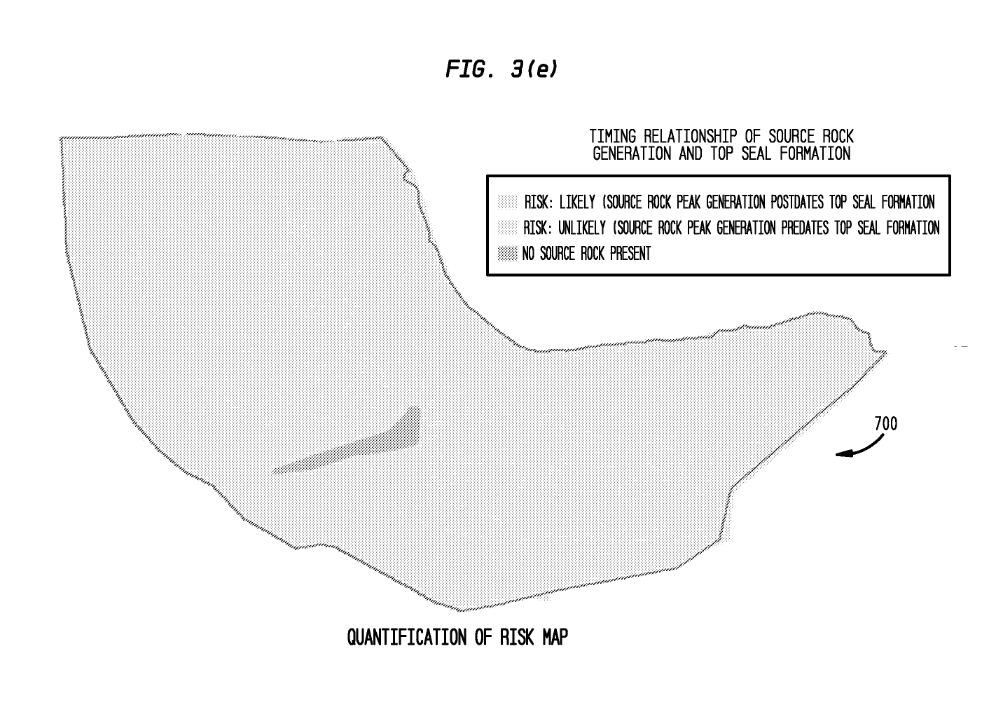

FIG. 3(a) shows one embodiment of a method 300 for quantifying risks or likelihoods of hydrocarbons being present in a geological region or basin. At step 302, a first digital x-y map corresponding to a basin or geological area or region of interest is generated, where z values thereof are ages at which specific values for a first petrophysical property are attained. Thus, at step 302 a first set of regional or local data corresponding to spatial and temporal variations in the first petrophysical property over at least portions of the region or local area are generated.

At step 304 of FIG. 3(a), a second digital x-y map corresponding to the same basin or geological area or region of interest is generated, where z values thereof are ages at which specific values for a second petrophysical property are attained. Thus, at step 304 a second set of regional or local data corresponding to spatial and temporal variations in the second petrophysical property over at least portions of the region or local area are generated. At step 306 of FIG. 3(a), the timing relationships between the first and second sets of data corresponding to the first and second petrophysical properties are quantified.

At steps 308 through 314 of FIG. 3(a), a series of conditional map operations are carried out on a third regional or local data set that represents a combination of at least portions of both the first data set and the second data set, where the third data set corresponds to combined spatial and temporal variations in the first and second petrophysical properties over the at least portions of the region or local area.

In FIG. 3(a), step 308 is an “IF” statement followed by either step 310 or step 312. At step 310 of FIG. 3(a), if the age for a first petrophysical property A is less than the age for the second petrophysical property, then the timing (age) relationship for hydrocarbons to be present is favorable, and then the risk for hydrocarbons to be present is likely. At step 312 of FIG. 3(a), if the age for the first petrophysical property A is greater than the age for the second petrophysical property, then the timing (age) relationship for hydrocarbons to be present is unfavorable and then the risk for hydrocarbons to be present is unlikely. For example, if the age of peak generation (petrophysical property A) is greater than the age of top seal formation (petrophysical property B), then the risk for hydrocarbons to be present is unlikely. At step 314 of FIG. 3(a), the risks are quantified by generating a risk map, where a visual display of the third set of data is generated that is configured to provide quantitative visual indications of degrees of risk or likelihood that hydrocarbons are present in the region or local area at specified locations thereof.

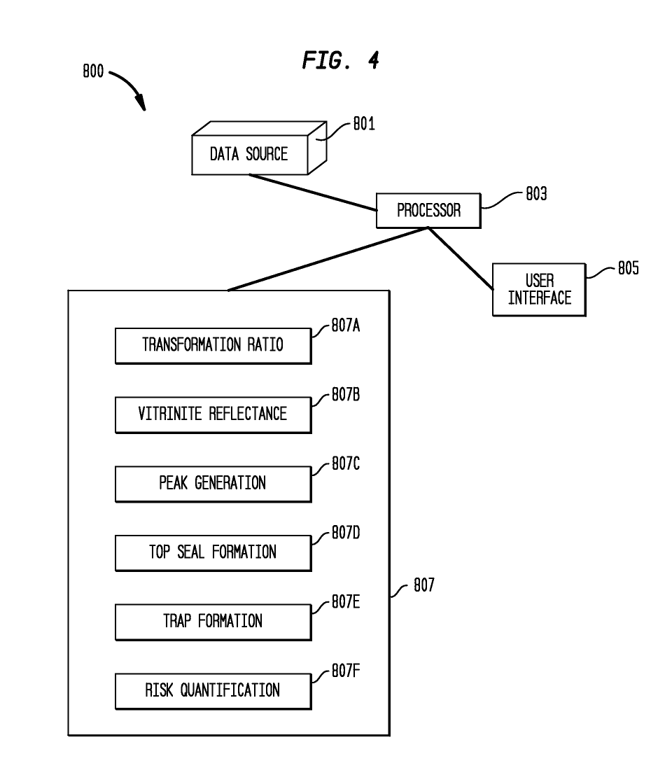

According to one embodiment, a risk quantification software module capable of executing the steps of FIG. 3(a) is provided that may be implemented or included in petroleum system modeling software packages such as, by way of example, Schlumberger's PetroMod® package, PARADIGM®'s GEOCAD® package, and Beicip-Franlab®'s TEMISPAK® package. (See, for example, software module 807F in FIG. 4.) In such embodiments, a risk quantification software module can be configured to operate in conjunction with PetroMod or other packages to process data and generate maps similar to those shown in FIGS. 3(b) and 3(c). In one such embodiment, a user selects two desired petrophysical properties from a list, and then executes a conditional map operation that yields a final risk map similar to that shown in FIG. 3(e).

Referring now to FIGS. 3(b) and 3(c), there are shown examples of first and second basin maps generated in accordance with the above-described methods that represent, respectively, geologic ages associated with peak generation of a late Eocene source rock (FIG. 3(b)), and geologic ages associated with the 14.8 Ma top seal formation (FIG. 3(c)). FIG. 3(e) represents a corresponding visual risk map of a third set of data that was generated on the basis of the first and second basin maps (and the first and second sets of data) that indicates whether the geologic time or age of peak generation for hydrocarbons in the late Eocene source rock predates or postdates the geologic time or age of top seal formation. The third map was generated using the above-described conditional map operations or “IF” statements.” The resulting risk quantification map of FIG. 3(e) shows areas in the basin having likely or favorable risks associated therewith, where source rock peak generation postdates top seal formation, as well as those areas in the basin or region having unlikely or unfavorable risks associated therewith, where source rock peak generation predates top seal formation.

FIG. 3(d) shows further details associated with the generation and interpretation of FIGS. 3(b) and 3(c), and the generation of the risk map shown in FIG. 3(e). Petroleum systems chart 602 of FIG. 3(d) shows one example of how timing relationships between different elements of a petroleum system (e.g., seal rock deposition, trap formation) can be visualized. In chart 600 and corresponding legends 604 and 606 of FIG. 3(d), two petroleum system elements (age of peak generation of oil, and age of top seal formation) are selected, and their timing relationship in highlighted. In the example of FIG. 3(d), peak generation of oil occurs at 17 ma before the age of top seal formation (at 14 ma). This is an unfavorable timing relationship (608).

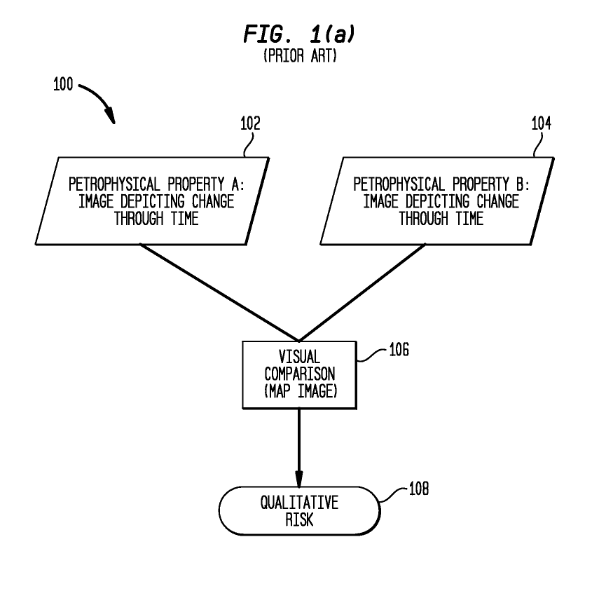

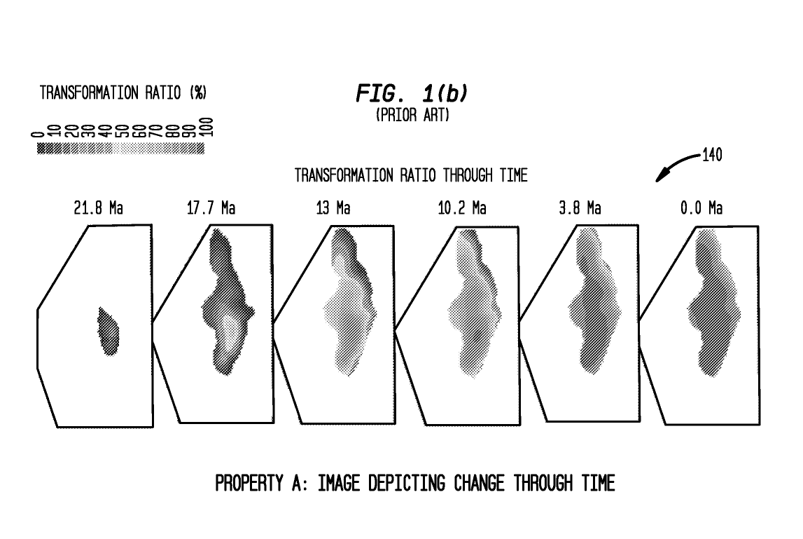

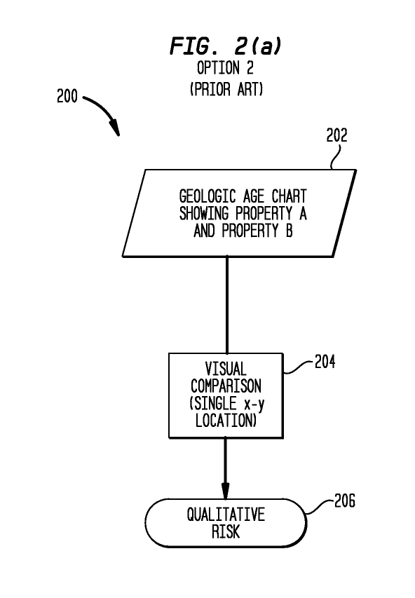

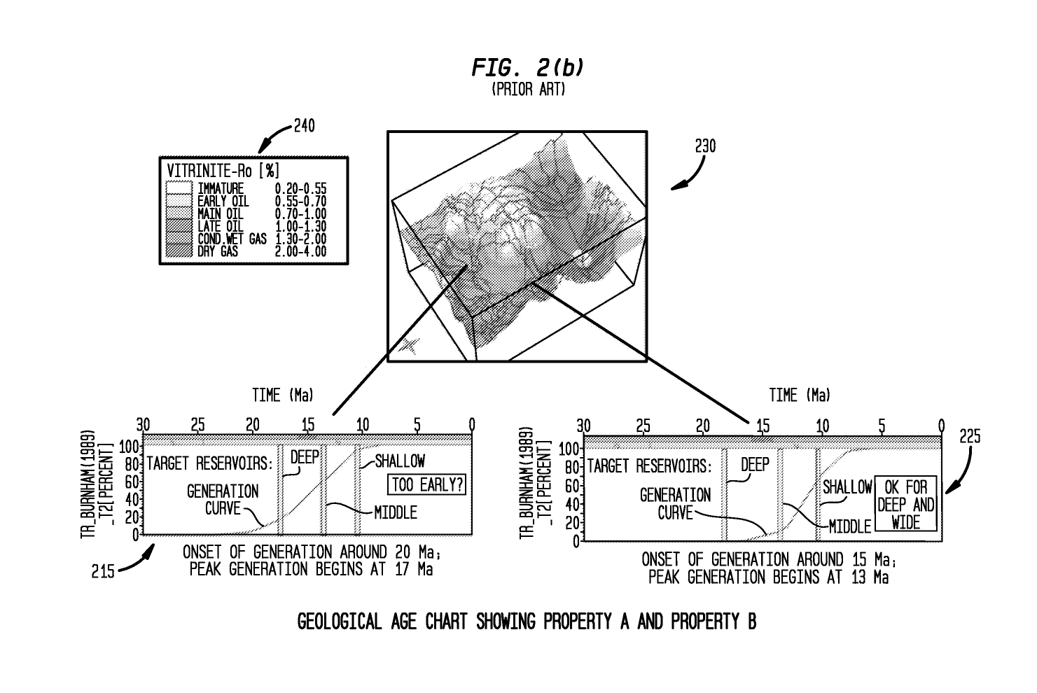

Referring now to FIGS. 1(a) through 3(e), and the corresponding descriptions and disclosure set forth above, the various embodiments of the methods and software modules disclosed and described herein may include, but are not limited to, methods and/or software modules where: (a) the temporal variations of the first, second or third sets of regional data are variations with respect to geologic time; (b) the spatial variations of the first, second or third sets of regional data are areal geographical variations; (c) the spatial variations of the first, second or third sets of regional data are two-dimensional or three-dimensional spatial variations; (d) the geological region is a geological basin; (e) the first petrophysical property or the second petrophysical property is one of peak hydrocarbon generation associated with a source rock formation, top seal formation in a geological or rock formation, vitrinite reflectance, a transformation ratio of a geological or rock formation, trap formation over or in a geological or rock formation, reservoir rock deposition, hydrocarbon formation from a source rock or geological formation, a type of rock or geological formation, geological maturity of a source rock formation, permeability of a source rock formation, porosity of a source rock formation, generation of hydrocarbons in a source rock formation, accumulation of hydrocarbons in a source or other type of rock formation, migration of hydrocarbons within or out of a source or other type of rock formation, loss of hydrocarbons from a source or other type of rock formation, structural evolution of a source or other type of rock formation, temperature of a source or other type of rock formation, and/or pressure of a source or other type of rock formation; (f) results provided by seismic data are combined with a third set of basin timing data; (g) results provided by well log or rock core data are combined with a third set of basin timing data.

Continuing to refer to FIGS. 1(a) through 3(e), and the corresponding descriptions and disclosure set forth above, the various embodiments of the software modules disclosed and described herein may include, but are not limited to, software modules where: (a) the software module is stored in at least one computer readable medium and configured for execution by a computer or processor; (b) the software module comprises first computer readable means stored in the computer readable medium and configured to generate a first set of regional data corresponding to spatial and temporal variations in a first petrophysical property over at least portions of a geologic region; second computer readable means stored in the computer readable medium and configured to generate a second set of regional data corresponding to spatial and temporal variations in a second petrophysical property over at least portions of the region; third computer readable means stored in the computer readable medium and configured to generate a third set of regional data on the basis of at least portions of the first and second sets of data, the third set of data corresponding to combined spatial and temporal variations in the first and second petrophysical properties over the at least portions of the region, and fourth computer readable means stored in the computer readable medium and configured to generate a visual display of the third set of data configured to provide quantitative visual indications of degrees of risk or likelihood that hydrocarbons are present in the region at one or more specified locations thereof; and (c) the module is configured to operate in conjunction with a petroleum systems modelling software package or program.

By way of example, various embodiments of the software modules disclosed and described herein may be implemented using, by way of example, Integrated Exploration Systems® (IES®) software configured for use with the aforementioned PetroMod package of Schlumberger. IES software is supported on Windows XP®, Windows VISTA®, Windows 7®, LINUX® and UNIX® operating systems on PC, Silicon Graphics Incorporated® (SGI®), and Sun computer platforms. The user interface and data formats are the same for all such platforms. Disk space, memory requirements, and processing time vary according to whether 2-D or 3-D models are generated on such platforms. PetroMod Express® freeware can be downloaded from the IES website, or full versions thereof purchased from IES.

Referring now to FIG. 4, and with further reference to FIG. 3(a), there is shown one embodiment of a system 800 configured to perform methods described above and in the Figures. As shown, system 800 comprises a data source/storage device 801 that includes a data storage device, computer memory, and/or a computer readable medium. Device 801 may contain or store, by way of example, petrophysical or geological data and/or synthetic petrophysical or geological data. Data from device 801 may be made available to processor 803, which may be, by way of example, a programmable general purpose computer, a CPU, a microprocessor, a plurality of processors, or any other suitable processor(s). Processor 803 is programmed with instructions corresponding to at least one of the various methods and modules described herein such that the methods or modules are executable by processor 803.

Continuing to refer to FIG. 4, and according to one embodiment, processor 803 is configured to execute one or more computer modules 807 that are configured to implement the above-disclosed methods, including the method shown in FIG. 3(a). Such computer modules may include, by way of example, a transformation ratio module 807A, a vitrinite reflectance module 807B, a peak oil or gas generation module 807C, a top seal formation module 807D, a trap formation module 807E, and/or a risk quantification module 807F (per FIG. 3(a)), as shown in FIG. 4.

Modules other than those shown in FIG. 4 are contemplated according to the various embodiments of the methods disclosed herein, including, but not limited to, reservoir rock deposition modules, hydrocarbon formation modules, rock type modules, geological maturity modules, permeability and/or porosity modules, hydrocarbon accumulation modules, hydrocarbon migration modules, hydrocarbon loss modules, structural geology modules, temperature modules, pressure modules, seismic data modules, well log modules, rock core modules, basin timing modules, reservoir charge or accumulation modules, uncertainty analysis modules, seal integrity modules, burial history modules, compaction modules, and/or petroleum migration modules.

Still referring to FIG. 4, system 800 may also comprise interface components such as user interface 805. User interface 805 may be used to display data and processed data products (such as with a computer monitor or display), and to allow the user to select among options for implementing aspects of the method (such as with a mouse and/or keyboard). By way of example and not limitation, first and second sets of data combined to form a third set of data as computed by processor 803 may be displayed on user interface 805, stored on data storage device or memory 801, or both displayed and stored.

Various embodiments of the methods and software modules disclosed and described herein may include, but are not limited to, one or more following advantages:
Quantification of risk as opposed to qualitative visual examination;
Visual (e.g., map or computer screen) representation of spatial timing relationships;
Visual (e.g., map or computer screen) representation of spatial risk relationships;
Objective assessment of risk;
Improved analysis and interpretation of the history of a sedimentary basin, and
Improved ability to integrate the results of this invention with other basin history relevant data.

The above-described embodiments should be considered as examples of the various embodiments, rather than as limiting the respective scopes thereof. In addition to the foregoing embodiments, review of the detailed description and accompanying drawings will show that there are other embodiments. Accordingly, many combinations, permutations, variations and modifications of the foregoing embodiments not set forth explicitly herein will nevertheless fall within the scope of the various embodiments.

1. A computer-implemented method of quantifying a risk or likelihood of hydrocarbons being present in a geological region, comprising:
generating a first set of regional data corresponding to spatial and temporal variations in a first petrophysical property over at least portions of the region;
generating a second set of regional data corresponding to spatial and temporal variations in a second petrophysical property over at least portions of the region;
generating a third set of regional data on the basis of at least portions of the first and second sets of data, the third set of data corresponding to combined spatial and temporal variations in the first and second petrophysical properties over the at least portions of the region, and
generating a visual display of the third set of data configured to provide quantitative visual indications of degrees of risk or likelihood that hydrocarbons are present in the region at specified locations thereof;
wherein each of the foregoing steps is performed by a processor operating in conjunction with a data storage device or memory, the processor being configured to execute instructions to perform each of the foregoing steps.

2. The method of claim 1, wherein at least one of the first, second and third sets of regional data comprise timing data and geographic data.

3. The method of claim 1, wherein the temporal variations of at least one of the first, second and third sets of regional data are variations with respect to geologic time.

4. The method of claim 1, wherein the spatial variations of at least one of the first, second and third sets of regional data are at least areal geographical variations.

5. The method of claim 1, wherein the spatial variations of at least one of the first, second and third sets of regional data are at least one of two-dimensional and three-dimensional spatial variations.

6. The method of claim 1, wherein the geological region is a geological basin.

7. The method of claim 1, wherein one of the first petrophysical property and the second petrophysical property is peak hydrocarbon generation associated with a source rock formation.

8. The method of claim 1, wherein one of the first petrophysical property and the second petrophysical property is top seal formation in a geological or rock formation.

9. The method of claim 1, wherein one of the first petrophysical property and the second petrophysical property is vitrinite reflectance.

10. The method of claim 1, wherein one of the first petrophysical property and the second petrophysical property is a transformation ratio of a geological or rock formation.

11. The method of claim 1, wherein one of the first petrophysical property and the second petrophysical property is trap formation over or in a geological or rock formation.

12. The method of claim 1, wherein one of the first petrophysical property and the second petrophysical property is reservoir rock deposition.

13. The method of claim 1, wherein one of the first petrophysical property and the second petrophysical property is hydrocarbon formation from a source rock or geological formation.

14. The method of claim 1, wherein one of the first petrophysical property and the second petrophysical property is a type of rock or geological formation.

15. The method of claim 1, wherein one of the first petrophysical property and the second petrophysical property is geological maturity of a source rock formation.

16. The method of claim 1, wherein one of the first petrophysical property and the second petrophysical property is permeability of a source rock formation.

17. The method of claim 1, wherein one of the first petrophysical property and the second petrophysical property is porosity of a source rock formation.

18. The method of claim 1, wherein one of the first petrophysical property and the second petrophysical property is generation of hydrocarbons in a source rock formation.

19. The method of claim 1, wherein one of the first petrophysical property and the second petrophysical property is accumulation of hydrocarbons in a source or other type of rock formation.

20. The method of claim 1, wherein one of the first petrophysical property and the second petrophysical property is migration of hydrocarbons within or out of a source or other type of rock formation.

21. The method of claim 1, wherein one of the first petrophysical property and the second petrophysical property is loss of hydrocarbons from a source or other type of rock formation.

22. The method of claim 1, wherein one of the first petrophysical property and the second petrophysical property is structural evolution of a source or other type of rock formation.

23. The method of claim 1, wherein one of the first petrophysical property and the second petrophysical property is temperature of a source or other type of rock formation.

24. The method of claim 1, wherein one of the first petrophysical property and the second petrophysical property is pressure of a source or other type of rock formation.

25. The method of claim 1, wherein the first petrophysical property is peak hydrocarbon generation associated with a source rock formation, and the second petrophysical property is top seal formation over or in the source rock formation.

26. The method of claim 1, further comprising combining results provided by seismic data with the third set of basin timing data.

27. The method of claim 1, further comprising combining results provided by well log or rock core data with the third set of basin timing data.

28. A software module, comprising:
first computer readable means stored in the computer readable medium and configured to generate a first set of regional data corresponding to spatial and temporal variations in a first petrophysical property over at least portions of a geologic region;
second computer readable means stored in the computer readable medium and configured to generate a second set of regional data corresponding to spatial and temporal variations in a second petrophysical property over at least portions of the region;
third computer readable means stored in the computer readable medium and configured to generate a third set of regional data on the basis of at least portions of the first and second sets of data, the third set of data corresponding to combined spatial and temporal variations in the first and second petrophysical properties over the at least portions of the region, and
fourth computer readable means stored in the computer readable medium and configured to generate a visual display of the third set of data configured to provide quantitative visual indications of degrees of risk or likelihood that hydrocarbons are present in the region at one or more specified locations thereof;
wherein the software module is stored in at least one computer readable medium and is configured for execution by a computer or processor, each of the foregoing steps is performed by the processor operating in conjunction with a data storage device or memory, the processor being configured to execute instructions to perform each of the foregoing steps.

29. The software module of claim 28, wherein the module is configured to operate in conjunction with a petroleum systems modelling software package or program.

30. The module of claim 28, wherein at least one of the first, second and third sets of regional data comprise timing data and geographic data.

31. The module of claim 28, wherein the temporal variations of at least one of the first, second and third sets of regional data are variations with respect to geologic time.

32. The module of claim 28, wherein the spatial variations of at least one of the first, second and third sets of regional data are at least areal geographical variations.

33. The module of claim 28, wherein the spatial variations of at least one of the first, second and third sets of regional data are at least one of two-dimensional and three-dimensional spatial variations.

34. The module of claim 28, wherein the geological region is a geological basin.

35. The software module of claim 28, wherein one of the first petrophysical property and the second petrophysical property is peak hydrocarbon generation associated with a source rock formation.

36. The software module of claim 28, wherein one of the first petrophysical property and the second petrophysical property is top seal formation in a geological or rock formation.

37. The software module of claim 28, wherein one of the first petrophysical property and the second petrophysical property is vitrinite reflectance.

38. The software module of claim 28, wherein one of the first petrophysical property and the second petrophysical property is a transformation ratio of a geological or rock formation.

39. The software module of claim 28, wherein one of the first petrophysical property and the second petrophysical property is trap formation over or in a geological or rock formation.

40. The software module of claim 28, wherein one of the first petrophysical property and the second petrophysical property is reservoir rock deposition.

41. The software module of claim 28, wherein one of the first petrophysical property and the second petrophysical property is hydrocarbon formation from a source rock or geological formation.

42. The software module of claim 28, wherein one of the first petrophysical property and the second petrophysical property is a type of rock or geological formation.

43. The software module of claim 28, wherein one of the first petrophysical property and the second petrophysical property is geological maturity of a source rock formation.

44. The software module of claim 28, wherein one of the first petrophysical property and the second petrophysical property is permeability of a source rock formation.

45. The software module of claim 28, wherein one of the first petrophysical property and the second petrophysical property is porosity of a source rock formation.

46. The software module of claim 28, wherein one of the first petrophysical property and the second petrophysical property is generation of hydrocarbons in a source rock formation.

47. The software module of claim 28, wherein one of the first petrophysical property and the second petrophysical property is accumulation of hydrocarbons in a source or other type of rock formation.

48. The software module of claim 28, wherein one of the first petrophysical property and the second petrophysical property is migration of hydrocarbons within or out of a source or other type of rock formation.

49. The software module of claim 28, wherein one of the first petrophysical property and the second petrophysical property is loss of hydrocarbons from a source or other type of rock formation.

50. The software module of claim 28, wherein one of the first petrophysical property and the second petrophysical property is loss of hydrocarbons from a source or other type of rock formation.

51. The software module of claim 28, wherein one of the first petrophysical property and the second petrophysical property is structural evolution of a source or other type of rock formation.

52. The software module of claim 28, wherein one of the first petrophysical property and the second petrophysical property is temperature of a source or other type of rock formation.

53. The software module of claim 28, wherein one of the first petrophysical property and the second petrophysical property is pressure of a source or other type of rock formation.

54. The software module of claim 28, wherein the first petrophysical property is peak hydrocarbon generation associated with a source rock formation, and the second petrophysical property is the formation of a top seal over the source rock formation.

55. A computer system configured to provide quantitative visual indications of degrees of risk or likelihood that hydrocarbons are present in the region at one or more specified locations thereof, comprising:
a data source containing a first set of regional data corresponding to spatial and temporal variations in a first petrophysical property over at least portions of a geologic region, and a second set of regional data corresponding to spatial and temporal variations in a second petrophysical property over at least portions of the region;
a computer processor configured to execute at least one computer module configured to generate a third set of regional data on the basis of at least portions of the first and second sets of data, the third data set corresponding to combined spatial and temporal variations in the first and second petrophysical properties over the at least portions of the region, and
a display configured to visually show the third set of data to a user, the third set of data providing a quantitative visual indication of degrees of risk or likelihood that hydrocarbons are present in the region at one or more specified locations thereof.

56. The system of claim 55, further comprising a user interface.
